(19) United States
(12) Patent Application Publication
(10) Pub. No.: US 2011/0051933 A1
(43) Pub. Date: Mar. 3, 2011

(54) PARING METHOD BETWEEN SM AND TP IN DOWNLOADABLE CONDITIONAL ACCESS SYSTEM, SET-TOP BOX AND AUTHENTICATION DEVICE USING THIS

(75) Inventors: Han-seung Koo, Daejeon-si (KR); O-Hyung Kwon, Daejeon-si (KR); Soo-in Lee, Daejeon-si (KR)

(73) Assignee: ELECTRONICS AND TELECOMMUNICATIONS RESEARCH INSTITUTE, Daejeon-si (KR)

(21) Appl. No.: 12/812,995

(22) PCT Filed: Nov. 23, 2009
(86) PCT No.: PCT/KR09/06901

§ 371 Date: Jul. 15, 2010

(30) Foreign Application Priority Data
Dec. 22, 2008 (KR) 10-2008-0131694

(51) Int. Cl. H04L 9/08; H04L 9/00

(52) U.S. Cl. 380/278; 380/44; 380/287

(57) ABSTRACT

The present invention relates to a technology of paring a secure micro (SM) and a transport processor (TP) in a downloadable conditional access system (DCAS). More specifically, predetermined security components generated by a trusted authority which is a certificate authority are previously embedded into the SM and the TP, and pairing between the SM and the TP is performed by association of the security components with the TA. Accordingly, safe pairing can be assured and the leakage of security information from the SM by malicious hacking can be prevented.

### TECHNICAL FIELD

The present invention relates to a technology of paring a secure micro (SM) and a transport processor (TP) in a downloadable conditional access system (DCAS).

### BACKGROUND ART

In general, a conditional access system (CAS) is a security technology for digital broadcasting, which allows only contractors to gain access to watch provided broadcasting programs. Conventionally, a CAS in a form of a cable card is mounted in a user's set-top box. Thus, when the user of a set-top box having the CAS therein wishes to change from one multiple service operator (MSO) to another, the user has to change the set-top box itself. To overcome such inconvenience, a downloadable CAS (DCAS) has been introduced, which is implemented in a software manner so that it can be downloaded to a set-top box.

The DCAS allows cable service subscribers not only to freely purchase a set-top box from retailers regardless of the multiple service operators (MSOs) the subscriber has a contract with, but also to be provided with pay-cable services from a different MSO without replacing the set-top box even when the subscribers change their MSO.

The above advantages can be achieved by the DCAS which allows images of security-required application programs, such as a CAS application, a digital right management (DRM) application and an authorized service domain (ASD) application, to be safely downloaded to secure micro (SM) which is a security chip in the set-top box and also allows the MSO to freely install and replace such applications from sources online.

One of the most critical security requirements for the DCAS is authentication of an SM in the MSO. If security images such as CA application images are transferred to an inappropriate SM, security algorithms and components can be exposed by hacking using techniques such as image decompiling, resulting in serious security problems.

Another important security requirement for the DCAS is authentication between the SM and a transport processor (TP). This is referred to as pairing between the SM and the TP. When pairing is not conducted properly, a control word (CW) can be hacked and a serious problem may occur in management of paid viewers.

One possible security threatened situation is when a hacked TP carries out an impersonation attack on the SM and intercepts the CW transferred by the SM. In this case, a hacker can easily access a paid broadcasting program using the intercepted CW. Another possible security threatened situation is when a hacker uses a CA application to detach an SM, which stores validation information for a viewer to access paid broadcasting programs, from a set-top box, and connects the detached SM with another set-top box which is not authenticated to provide paid broadcasting programs. In this case, an MSO cannot manage paid subscribers properly, causing the loss of profit.

### DISCLOSURE OF INVENTION

### Technical Problem

The present invention relates to a security protocol for overcoming an issue of pairing between a secure micro (SM) and a transport processor (TP) which is one of the most critical security requirements for a downloadable conditional access system (DCAS).

An object of the present invention is to prevent a user from illegally connecting an SM to a TP of an invalid set-top box or to prevent a hacked TP from maliciously leaking security information out of the SM.

### Technical Solution

In one general aspect, there is provided a method of pairing a secure micro (SM) for security processing and a transport processor (TP) for descrambling scrambled contents, the method including: exchanging, between the SM and TP, the security components of each of the SM and the TP; receiving a result of a validation check with respect to the security components; and generating encryption keys for encrypting data to be transmitted between the SM and the TP based on the validation check result.

The security components may be pre-assigned to the SM and the TP by a trusted authority (TA) and include at least one of a trusted authority (TA) certificate, device certificates which each include an ID of each of the SM and the TP, and a Diffie-Hellman (DH) prime(n) and a DH base(g) for a DH key exchange algorithm.

The generating of the encryption key may include: generating public keys at the SM and the TP using the validation check result and exchanging the generated public keys between the SM and the TP; generating authentication keys at the SM and the TP using the exchanged public keys; and exchanging the authentication keys between the SM and the TP and generating the encryption keys.

The public keys may be DH keys and exchanged using a Diffie-Hellman key exchange algorithm.

The authentication keys may be generated using a hash function.

The validation check with respect to the security components may be performed by a trusted authority (TA) which is a certificate authority.

In another general aspect, there is provided a method of pairing a secure micro (SM) for security processing and a transport processor (TP) for descrambling scrambled contents, the method including: assigning, at a trusted authority (TA), security components to the SM and the TP; receiving, at the TA, the security components of the SM and the TP and performing a validation check with respect to the received security components; and informing the SM or the TP of the validation check result.

When the security components are valid, a key pairing key (KPK) required for generating the authentication key may be transmitted to the SM.

The validation check may be performed with respect to identifications of the respective SM and the TP which are included in the security components, and performed based on a certificate revocation list (CRL) according to whether or not a certificate containing either the identification of the SM or the identification of the TP is revoked.

In still another general aspect, there is provided a set-top box of a downloadable conditional access system (DCAS), the set-top box including: a secure micro (SM) for security processing; and a transport processor (TP) for descrambling scrambled contents, wherein the set-top box receives a validation check result with respect to security components assigned to the SM and the TP and generates an encryption key to be used for encrypting data to be transmitted between the SM and the TP based on the received validation check result.

In yet another general aspect, there is provided an authentication device of a down-loadable conditional access system (DCAS) which is connected with a set-top box through an authentication proxy, wherein the set-top box includes a secure micro (SM) for security processing and a transport processor (TP) for descrambling scrambled contents and the authentication device assigns security components to the SM and the TP, performs a validation check with respect to the security components of the SM and the TP and informs the SM or the TP of the validation check result.

Additional features of the invention will be set forth in the description which follows, and in part will be apparent from the description, or may be learned by practice of the invention.

### ADVANTAGEOUS EFFECTS

Security components are previously embedded in a secure micro (SM) and a transport processor (TP), and pairing between the SM and the TP is performed by association of the embedded security components with a trusted authority (TA), and thus safer pairing can be assured, compared to a conventional method, and an illegal connection between the SM with a TP of an invalid set-top box or malicious leakage of security information from the SM by a hacked TP can be prevented.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a downloadable conditional access system (DCAS) according to an exemplary embodiment.

FIG. 2 illustrates security components to be embedded in a secure micro (SM) and a transport processor (TP) according to an exemplary embodiment.

FIG. 3 is a flowchart illustrating pairing processes according to an exemplary embodiment.

FIG. 4 is a flowchart illustrating in detail the initialization process of FIG. 3.

FIG. 5 is a flowchart illustrating in detail the key pairing ID validation check process of FIG. 3.

FIG. 6 is a flowchart illustrating the Diffie-Hellman (DH) key exchange process and the authentication key generating process of FIG. 3.

FIG. 7 is a flowchart illustrating the encryption key generating process of FIG. 3.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

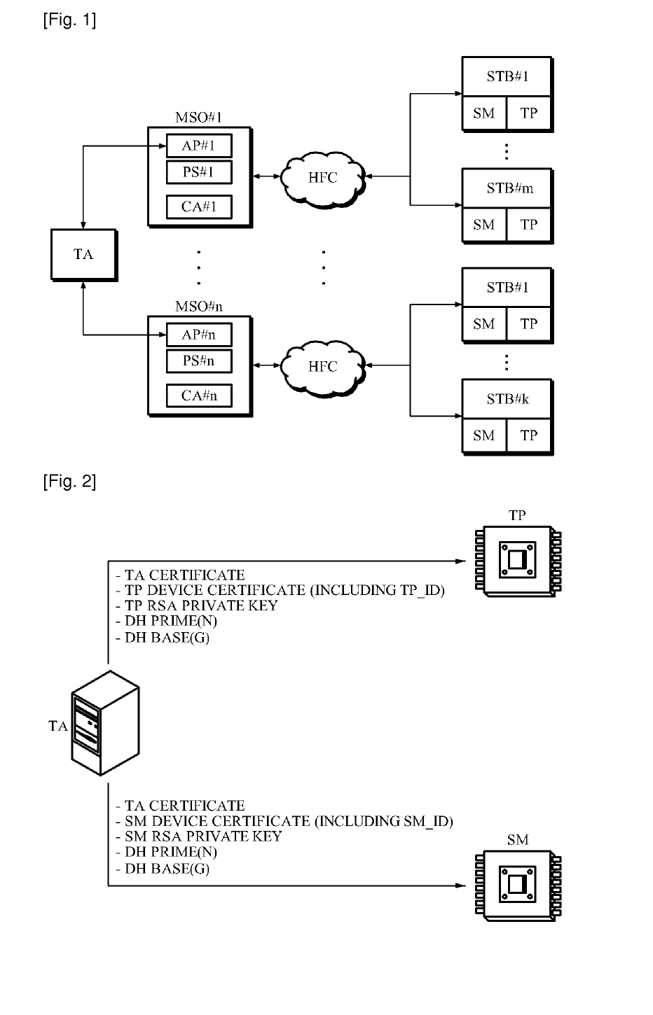

FIG. 1 is a diagram illustrating a downloadable conditional access system (DCAS) according to an exemplary embodiment. Referring to FIG. 1, the DCAS includes a plurality of set-top boxes (STBs), each having a secure micro (SM) for security processing and a transport processor for descrambling scrambled contents, a plurality of multiple service operators (MSOs), and a trusted authority (TA) which is a certificate authority or an authentication device.

Each MSO may include an authentication proxy which acts as an agent for a TA, and a personalization server (PS) which manages images of application programs to be transferred to STBs.

Each STB can download a certificate from the TA through the AP. The certificate is personalized by the SM of the STB. Encrypted contents provided to the STB are decrypted by the TP. Here, if the SM and the TP are not connected properly in terms of security, that is, when pairing between the SM and TP is not properly conducted, external hacking and a serious problem in which viewers which have paid for contents do not receive them due to hacking of their SM may occur can take place.

In the exemplary embodiment, a problem of pairing between the SM and the TP which is a primary security requirement for the DCAS can be overcome by use of the TA. For example, predetermined security components may be previously embedded in the SM and the TP, and when the security components are exchanged between the SM and the TP, the TA may intervene in the exchange process to generate a public key, an authentication key, and an encryption key.

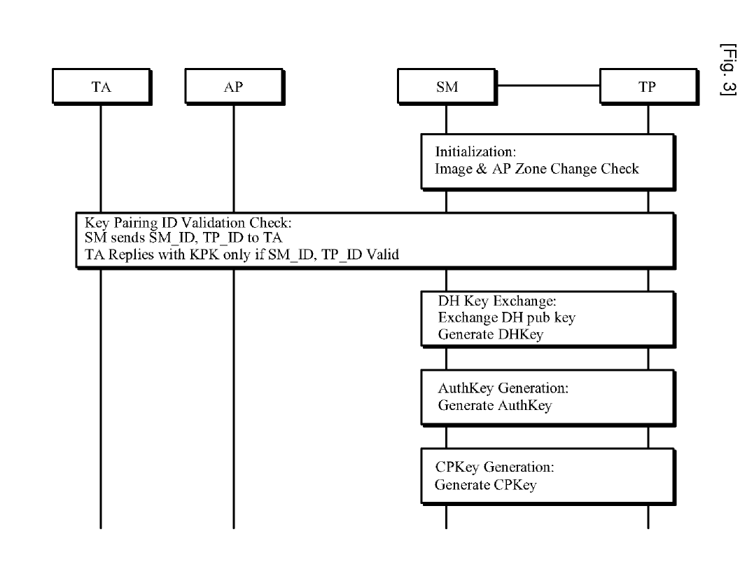

FIG. 2 illustrates security components to be embedded in the SM and the TP according to an exemplary embodiment. Referring to FIG. 2, the security components to be embedded in the SM and the TP are generated in the TA. Specifically, to embed the security components, SM or TP chip manufacturers may personally visit the TA to port the security components, or receive the security components through separate lines which are safe in terms of security.

The security components to be embedded in an SM and a TP will be described below. A first security component to be embedded in the TP is a TA certificate containing a public key of the TA. The TA certificate may be a self-signed certificate. A second security component is a TP device certificate containing a public key of the TP. The TP device certificate may include a TP identification value in a ‘subject common name’ field, and may be digitally signed with a private key of the TA. A third security component is a Rivest-Shamir-Adelman (RSA) private key of 1024 bits which corresponds to the private key of the TP. A fourth security component is a Diffie-Hellman (DH) prime(n) for DH key exchange algorithm, and a fifth security component is a DH base(g) for DH key exchange algorithm.

The security components embedded in the SM correspond to those embedded in the TP. That is, the TA certificate, the DH prime(n), and the DH base(g) embedded in the SM are the same as those embedded in the TP. Additionally, in a ‘subject common name’ field of a certificate of the SM, an SM device certificate containing an SM ID value and an RSA private key corresponding to a private key of the SM are embedded.

FIG. 3 is a flowchart illustrating pairing processes according to an exemplary embodiment. Referring to FIG. 3, the pairing processes include an initialization process, a validation check process, a DH key exchange process, an authentication key generating process, and an encryption key generating process, which are performed in association with a TA.

Each process will now be described in brief below.

In the initialization process, the SM and TP exchange their security components. The security components are as described in FIG. 2. In the validation check process, the TA receives the security components from the SM and checks whether the received security components are valid. If it is confirmed that the security components are valid, the DH key exchange process is performed. In the DH key exchange process, the SM and the TP generate and exchange DH public keys. Once the DH public keys are exchanged, the SM and the TP generate and exchange authentication keys, and then generate and exchange encryption keys. The finally generated encryption keys may be used as encryption means when the SM and the TP transmit messages.

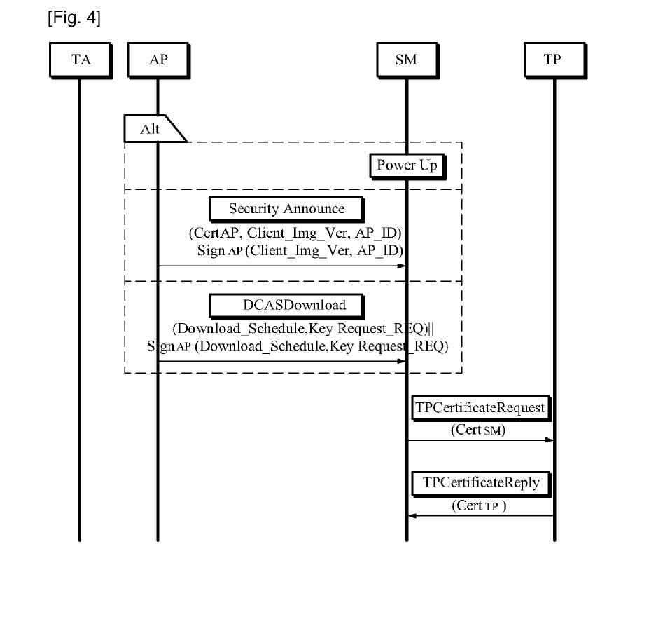

FIG. 4 is a flowchart illustrating in detail the initialization process of FIG. 3.

The initialization process in which the SM and the TP exchange their security components to obtain the security components of the corresponding party may be commenced in cases described below. When the SM is powered up, when the SM is notified by an AP that an AP zone is changed by altering an AP_ID value in a SecurityAnnounce message, when the SM learns that an SM client image is updated after the SM receives a DCASDownload message from the AP, or when the SM in virgin state gains the first access to a cable network, the initialization process may be started.

If one of the above four events is satisfied, the SM and the TP exchange their security components, and particularly, they may exchange their device certificates. For example, the SM transmits a TPCertificateRequest message containing an SM device certificate (Cert_{SM}) to the TP. The TP which receives the TPCertificateRequest message may transmit a TPCertificateReply message containing a TP device certificate (Cert_{TP}) to the SM. The device certificates may each include an SM_ID value and a TP_ID value in their ‘subject common name’ fields.

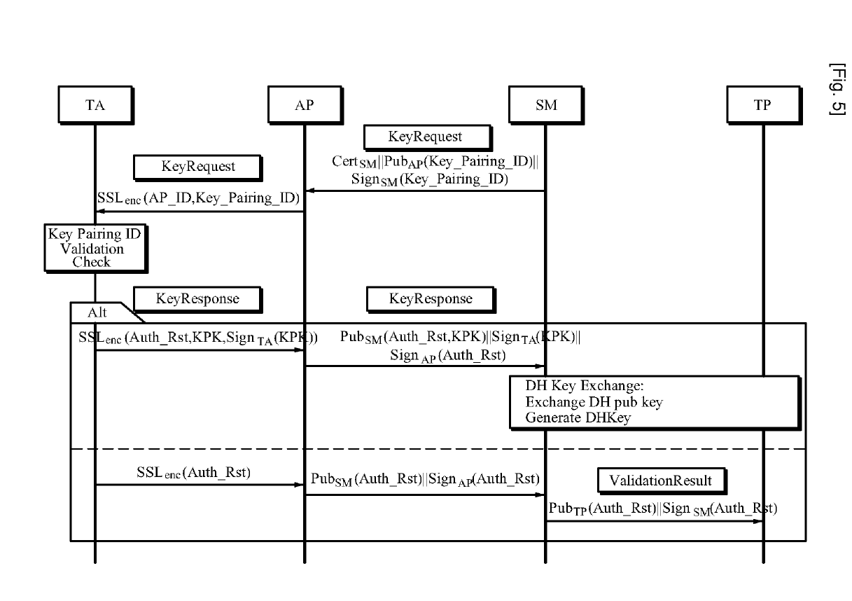

FIG. 5 is a flowchart illustrating in detail the validation check process of FIG. 3. Referring to FIG. 5, the SM transmits the TP_ID obtained through the initialization process and its SM_ID to the TA. Then, the TA checks a certificate revocation list (CRL) to determine whether a certificate including the SM_ID and the TP_ID received from the SM is revoked. If both the SM_ID and the TP_ID pass the validation check, the TA transmits a validation result (Auth_Rst) and a key pairing key (KPK) to the SM and the TP.

More specifically, the SM transmits to the AP a KeyRequest message relevant to the Cert_{SM} that is the certificate of the SM, a Pub_{AP}(Key_Pairing_ID) which is obtained by encrypting the Key Pairing ID with an RSA public key of the AP, and a Sign_{SM} (Key_Pairing_ID) which is obtained as the result of the Key_Pairing_ID being digitally signed with an RSA private key of the SM. In this case, the Key_Pairing_ID value may be a value relevant to the SM_ID and the TP_ID.

The AP encrypts an AP_ID value and the Key_Pairing_ID value with a secure socket layer (SSL) scheme, and transmits a KeyRequest message including the resultant value of the encryption to the TA.

The TA obtains the SM_ID and the TP_ID from the Key_Pairing_ID, and checks whether both IDs are valid using the CRL.

If the SM_ID and the TP_ID are valid, the TA encrypts the Auth_Rst including a success value which is the result of the validation, the Key Pairing Key (KPK), which is required for future AutheKey generation, and a SignTA(KPK), which is an RSA-digitally signed KPK, with an SSL scheme, and transmits a KeyResponse message including the resultant value of the encryption to the AP. Thereafter, the AP transmits to the SM a KeyResponse message connected with a Pub_{SM}(Auth_RST, KOK) obtained by encrypting the Auth_Rst and the KPK with the public key of the SM, a Sign_{TA}(KPK) obtained from the KPK signed digitally with the RSA private key of the TA and a Sign_{AP}(Auth_Rst) obtained from the Auth_Rst signed digitally with the RSA private key of the AP.

Subsequently, the SM and the TP perform the DH key exchange process which will be described later.

If either the SM_ID or the TP_ID are invalid, the TA encrypts an Auth_Rst including a failure value that is a validation result with the SSL scheme, and transmits a KeyResponse message containing the encryption result to the AP. Thereafter, the AP transmits the KeyResponse message relevant to a Pub_{SM}(Auth_Rst), which is obtained by encrypting the Auth_Rst with the public key of the SM, and a Sign_{AP}(Auth_Rst), which is obtained by encrypting the Auth_Rst with the private key of the AP. Then, the SM transmits to the TP a KeyResponse message connected with a Pub_{TP}(Auth_Rst), which is obtained by encrypting the Auth_Rst with the public key of the TP, and a Sign_{SM}(Auth_Rst), which is obtained by encrypting the Auth_Rst with the private key of the SM.

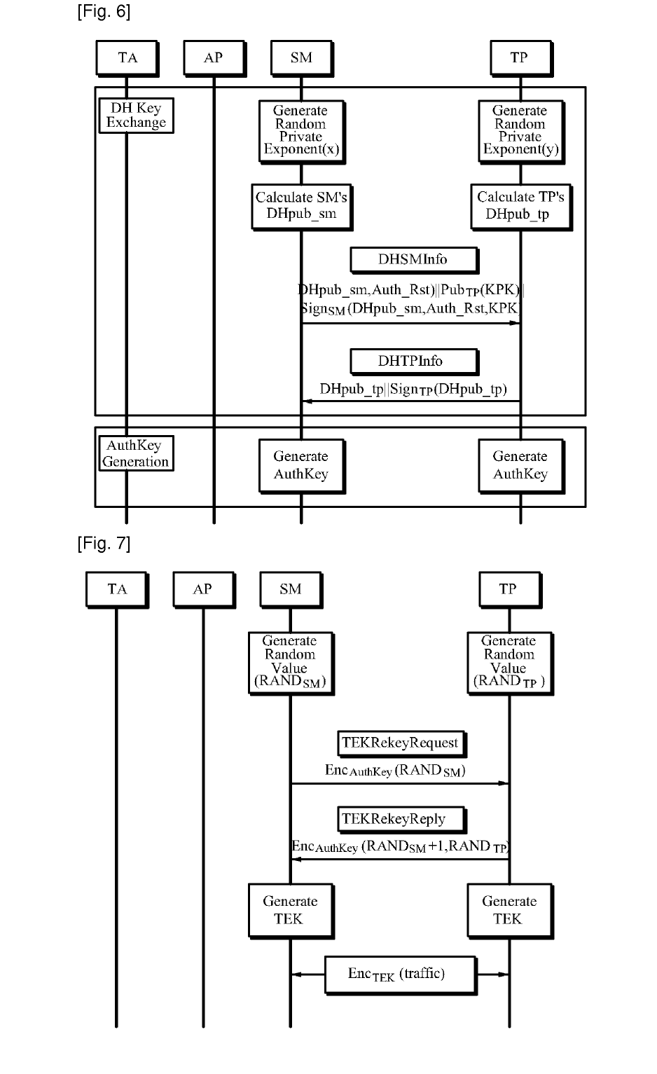

FIG. 6 is a flowchart illustrating the DH key exchange process and the authentication key generating process of FIG. 3.

The DH key exchange process can be performed only when the SM receives Auth_Rst having a success value from the TA, and in this process, the SM and the TP exchange their DH public keys. The exchanged DH public keys may be used as input values for generating DH keys later.

More specifically, the SM and the TP, respectively, generate x and y which are random values to be used as private exponent values for generating the DH keys. Subsequently, the SM and the TP respectively generate the DH public keys, i.e., DHpub_sm and DHpub_tp, according to a DH algorithm. Then, the SM transmits to the TP a DHSMInfo message connected with a Pub_{TP}(KPK), which is obtained by encrypting the DHpub_sm, the Auth_Rst and the KPK with the RSA public key of the TP, and a Sign_{SM}(DHpub_sm,Auth_Rst,KPK), which is obtained from the Dhpub_sm, wherein the Auth_Rst and the KPK are digitally signed with the RSA private key of the SM. Then, the TP transmits to the SM the DHpub_tp and a Sign_{TP}(DHpub_tp) which is obtained from the DHpub_tp being digitally signed with the RSA public key of the TP.

In the authentication key generating process, the authentication key may be generated by executing a hash function on values obtained from the DH key generating process and the initialization process described above. For example, the authentication key AuthKey may be represented as follows:

AuthKey=HASH[DHKey,KPK,SM_ID,TP_ID] Expression 1

Here, DHKey and KPK are values obtained from the public key exchange process, and SM_ID and TP_ID are values obtained from the initialization process.

FIG. 7 is a flowchart illustrating the encryption key generating process of FIG. 3. In this process, a TEK is an encryption key to be used for encrypting data to be transmitted between the SM and the TP.

The encryption key generating process illustrated in FIG. 7 may be commenced each time the authentication key generating process finishes, or at the end of each session predetermined by both the SM and the TP, for example, when the SM transmits a TEKRekeyRequest message to the TP, even when the authentication key generating process is not completed.

Specifically, the SM and the TP respectively generate RAND_{SM} and RAND_{TP} which are random values. Then, the SM transmits EncAuthKey(RAND_{SM}), which is obtained by encrypting the RAND_{SM} with the AuthKey, to the TP. Thereafter, the TP transmits EncAuthKey(RAND_{SM}+1,RAND_{TP}), which is obtained by encrypting RAND_{SM}+1 and the RAND_{TP} with the AuthKey, to the SM. Each of the SM and the TP can generate a TEK using a hashing function as follows:

TEK=HASH[DHKey,AuthKey,RAND_{SM},RAND_{TP}] Expression 2

The TP and the SM encrypt data to be transmitted therebetween using the TEKs as encryption keys, and thus pairing can be performed.

As apparent from the above description, pairing between the SM and the TP can be easily performed, which is one of the most important security requirements for a DCAS, by using the security components embedded in each of the SM and the TP and associating with the TA during security process.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of pairing a secure micro (SM) for security processing and a transport processor (TP) for descrambling scrambled contents, the method comprising:
exchanging, between the SM and TP, the security components of each of the SM and the TP;
receiving a result of a validation check with respect to the security components; and
generating encryption keys for encrypting data to be transmitted between the SM and the TP based on the validation check result.

2. The method of claim 1, wherein the security components include at least one of a trusted authority (TA) certificate, device certificates which each include an identification of each of the SM and the TP, a Rivest-Shamir-Adelman (RSA) private key, and a Diffie-Hellman (DH) prime(n) and a DH base(g) for a DH key exchange algorithm.

3. The method of claim 1, wherein the security components exchanged between the SM and the TP are device certificates.

4. The method of claim 1, wherein the generating of the encryption key comprises:
generating public keys at the SM and the TP using the validation check result and exchanging the generated public keys between the SM and the TP;
generating authentication keys at the SM and the TP using the exchanged public keys; and
exchanging the authentication keys between the SM and the TP and generating the encryption keys.

5. The method of claim 4, wherein the exchanging of the public keys comprises exchanging DH public keys using a Diffie-Hellman key exchange algorithm.

6. The method of claim 4, wherein the authentication keys are generated using a hash function.

7. The method of claim 1, wherein the validation check with respect to the security components is performed by a trusted authority (TA) which is a certificate authority.

8. The method of claim 1, wherein the security components are previously assigned to the SM and the TP by a trusted authority (TA) which is a certificate authority.

9. A method of pairing a secure micro (SM) for security processing and a transport processor (TP) for descrambling scrambled contents, the method comprising:
assigning, at a trusted authority (TA), security components to the SM and the TP;
receiving, at the TA, the security components of the SM and the TP and performing a validation check with respect to the received security components; and
informing the SM or the TP of the validation check result.

10. The method of claim 9, wherein the security components include more than one of a TA certificate, device certificates which each include an identification of each of the SM and the TP, a Rivest-Shamir-Adelman (RSA) private key, and a Diffie-Hellman (DH) prime(n) and a DH base(g) for a DH key exchange algorithm.

11. The method of claim 9, wherein the validation check result is encrypted prior to the informing.

12. The method of claim 9, wherein when the security components are valid, a key pairing key (KPK) required for generating the authentication key is transmitted to the SM.

13. The method of claim 9, wherein the validation check is performed with respect to identifications of the respective SM and TP which are included in the security components.

14. The method of claim 13, wherein the validation check is performed based on a certificate revocation list (CRL) according to whether or not a certificate containing either the identification of the SM or the identification of the TP is revoked.

15. A set-top box of a downloadable conditional access system (DCAS), the set-top box comprising:
a secure micro (SM) for security processing; and
a transport processor (TP) for descrambling scrambled contents,
wherein the set-top box receives a validation check result with respect to security components assigned to the SM and the TP and generates an encryption key to be used for encrypting data to be transmitted between the SM and the TP based on the received validation check result.

16. The set-top box of claim 15, wherein the security components include more than one of a trusted authority (TA) certificate, device certificates which each include an ID of each of the SM and the TP, an RSA private key, and a Diffie-Hellman (DH) prime(n) and a DH base(g) for a DH key exchange algorithm.

17. The set-top box of claim 15, wherein the security components are assigned by a trusted authority (TA) which is a certificate authority.

18. An authentication device of a downloadable conditional access system (DCAS) which is connected with a set-top box through an authentication proxy, wherein the set-top box includes a secure micro (SM) for security processing and a transport processor (TP) for descrambling scrambled contents and the authentication device assigns security components to the SM and the TP, performs validation check with respect to the security components of the SM and the TP and informs the SM or the TP of a validation check result.

19. The authentication device of claim 18, wherein the security components include more than one of a trusted authority (TA) certificate, device certificates which each include an ID of each of the SM and the TP, an RSA private key, and a Diffie-Hellman (DH) prime(n) and a DH base(g) for a DH key exchange algorithm.

20. The authentication device of claim 18, wherein when the security components are valid, a key pairing key (KPK) required for generating the authentication key is provided to the SM.
